(19) United States
(12) Patent Application Publication
(10) Pub. No.: US 2025/0291622 A1
(43) Pub. Date: Sep. 18, 2025

(54) Virtual Computer Model-Based Fuzz Testing System and Method

(71) Applicants: Kee Sup Kim, El Dorado Hills, CA (US); Younggwang Jung, Incheon (KR); Eun Taek Oh, Seoul (KR); Jiwoo Nam, Seoul (KR); Yeong Bin You, Seongnam (KR)

(72) Inventors: Kee Sup Kim, El Dorado Hills, CA (US); Younggwang Jung, Incheon (KR); Eun Taek Oh, Seoul (KR); Jiwoo Nam, Seoul (KR); Yeong Bin You, Seongnam (KR)

(73) Assignee: Axion Co. Ltd., Seongnam (KR)

(21) Appl. No.: 19/081,044

(22) Filed: Mar. 17, 2025

Related U.S. Application Data
(60) Provisional application No. 63/566,305, filed on Mar. 17, 2024.

(51) Int. Cl. G06F 9/455

(52) U.S. Cl. CPC G06F 9/45558; G06F 2009/45587

(57) ABSTRACT

The present invention provides a fuzz testing system and method based on a virtual computer model. Traditional fuzz testing approaches primarily modify external inputs to detect security vulnerabilities, making it difficult to monitor internal state changes in real-time. This invention constructs a test environment using a virtual computer model and incorporates automatic assertion generation and detection functions, enabling precise analysis of both internal and external signals of the system. After executing fuzz testing, assertion data is analyzed to assess test coverage and identify untested code regions, allowing for an optimized testing strategy. This improves the detection rate of security vulnerabilities, enhances test automation and reliability, and can be applied in various fields such as networks, automotive ECUs, IoT, finance, aerospace, and semiconductors.

### DETAILED DESCRIPTION OF THE INVENTION

### Overview of the Invention

The present invention relates to a fuzz testing system and method utilizing a Virtual Computer Model. Traditional fuzz testing methods involve injecting random inputs into software or hardware systems to induce abnormal behavior and detect security vulnerabilities. However, existing approaches primarily manipulate external input values of the system, making it difficult to effectively detect internal state changes or security events. Additionally, there is a lack of quantitative metrics to evaluate test coverage, making it challenging to determine whether specific vulnerabilities have been sufficiently tested.

To address these issues, the present invention constructs a test environment based on a Virtual Computer Model and provides a fuzz testing system and method that includes automatic assertion generation and detection functions. By leveraging a virtual model, this approach achieves higher visibility and precision than traditional fuzz testing conducted on physical systems, allowing real-time monitoring of internal and external signals. This enables more effective detection and analysis of security events that occur during testing.

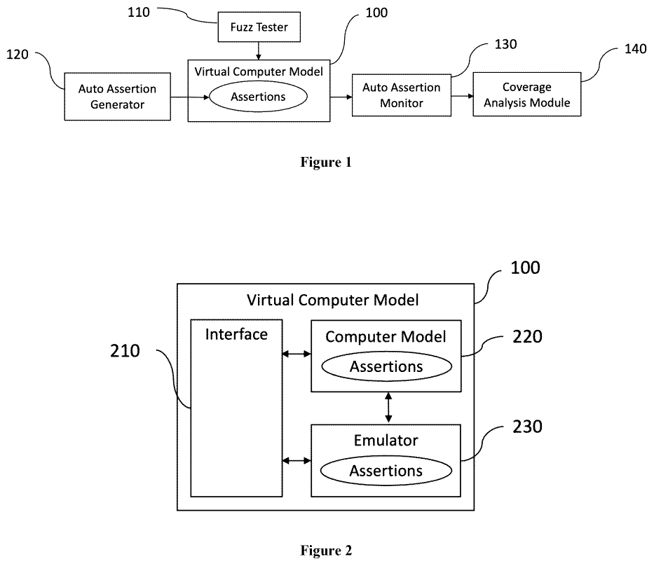

FIG. 1 illustrates the overall structure of the fuzz testing system of the present invention. The system primarily consists of (1) a Virtual Computer Model (100), (2) a Fuzz Tester (110), (3) an Auto Assertion Generator (120), (4) an Auto Assertion Monitor (130), and (5) a Coverage Analysis Module (140).
Virtual Computer Model (100): Virtualizes the target system, detecting internal and external signals in real-time and analyzing how test inputs affect system behavior. This model simulates the operation of the system at both the software and hardware levels, enabling security verification.
Fuzz Tester (110): Generates random inputs (Fuzzed Input) and injects them into the Virtual Computer Model (100). This allows the system to automatically explore input values that may cause unexpected behavior or security vulnerabilities, facilitating diverse test scenarios.
Auto Assertion Generator (120): Analyzes the Virtual Computer Model and automatically generates expected assertions. Before test execution, this module anticipates system behavior and security events, defining specific conditions that may trigger assertions to improve test reliability.
Auto Assertion Monitor (130): Monitors security events in real-time during fuzz testing and analyzes assertion data to evaluate the presence of vulnerabilities. Traditional fuzz testing methods typically check only for crashes or abnormal behavior. However, the present invention utilizes a Test Coverage Metric to quantitatively analyze test coverage and identify untested code regions or scenarios.
Coverage Analysis Module (140): Analyzes assertion data detected during fuzz testing to evaluate test coverage and identify untested code regions. This module determines whether certain code paths have been inadequately tested or if additional verification is needed.

In FIG. 1, Assertions represent verification logic that is activated when specific conditions are met within the Virtual Computer Model. When fuzzed inputs are injected into the system, triggering a predefined assertion enables evaluation of system behavior and identification of security vulnerabilities. The detected assertion data is later used for security event analysis and test coverage evaluation, providing a more accurate assessment of the system's security status.

The fuzz testing system of the present invention offers higher security vulnerability detection rates and improved test reliability compared to traditional methods. Additionally, it enhances efficiency by automating the security verification process. The proposed system is applicable to network protocol testing, automotive ECU security assessment, firmware validation, and various other fields. It provides a more effective approach to security evaluation and test automation compared to conventional fuzz testing techniques.

### General System Architecture & Components

The fuzz testing system of the present invention is designed to establish a test environment based on a Virtual Computer Model and perform security verification by incorporating automatic assertion generation and detection functions. Traditional fuzz testing methods are typically performed on physical systems, making it challenging to monitor internal state changes in real time during the testing process. Additionally, it is difficult to quantitatively evaluate whether security vulnerabilities have been sufficiently tested.

To address these limitations, the present invention provides a Virtual Computer Model that enables fuzz testing in a virtualized environment, incorporating an Auto Assertion Monitor for detecting security events by analyzing internal and external signals and a Test Coverage Metric for evaluating test coverage. This allows for a higher level of security verification and improved test reliability compared to existing methods.

The proposed fuzz testing system consists of the following key components: a Virtual Computer Model, an Auto Assertion Generator, an Auto Assertion Monitor, and a Test Coverage Metric Module. The Virtual Computer Model virtualizes the target system, detecting internal and external signals in real time and analyzing how test inputs affect system behavior. The Auto Assertion Generator defines expected security events based on the structure of the Virtual Computer Model and automatically generates assertions that may occur during test execution.

Additionally, the Auto Assertion Monitor continuously monitors security events during test execution, analyzing assertion data to evaluate whether security vulnerabilities exist. While traditional fuzz testing primarily checks for crashes or abnormal behavior, the present invention leverages a Test Coverage Metric to quantitatively assess test coverage and identify untested code regions.

After fuzz testing is completed, the system analyzes detected assertion data to identify untested code areas and evaluate whether undetected security vulnerabilities are present. Traditional fuzz testing methods struggle to systematically assess whether certain vulnerabilities have been adequately tested or whether certain code regions remain untested. However, the present invention analyzes assertion frequency to identify areas with insufficient test coverage and determines whether additional testing is necessary.

For example, if assertions rarely occur within a specific code block, it is likely that the area has not been sufficiently tested. Based on this result, the system can generate additional input data for untested code regions or adjust the test strategy to improve test completeness. This approach enhances security vulnerability detection rates and enables a more quantitative evaluation of test coverage compared to traditional fuzz testing.

The Test Coverage Analysis function of the present invention automatically identifies untested code regions and, if necessary, recommends additional testing. This improves the reliability of fuzz testing and prevents critical security vulnerabilities from being overlooked. Furthermore, by optimizing test paths based on detected assertion data, the system avoids the issue of executing only repetitive test paths in specific code blocks and enables broader exploration of diverse code regions. This approach expands test coverage in a more balanced manner and further enhances security vulnerability detection rates.

The following sections provide a detailed explanation of each component of the present invention.

### Virtual Computer Model

The virtual computer model is a software-based model that virtualizes the testing environment for performing fuzz testing. It models the behavior and functions of the target system or specific designs (e.g., circuit designs, SoC designs) through software, enabling system validation without the need for physical hardware. This invention's virtual computer model can be implemented using programming languages such as SystemC, C++, and Python and includes functionality to monitor internal system states and security events during fuzz testing.

Some modules within the virtual computer model may be replaced with emulators. Emulators are programs or devices that virtualize a particular system through software while replicating real hardware operations. For example, in modern SoC design, major computing units such as GPUs or CPUs can be verified using emulators to create an environment similar to actual operation, achieving higher modeling accuracy. Specifically, leveraging FPGA allows for a more precise virtual model at the hardware level.

To conduct fuzz testing, a test interface must be configured within the virtual computer model. This interface may consist of input ports or bidirectional I/O ports of the virtual model and can be provided in various forms depending on the structure of the target system. Examples include a network interface for injecting network packets to evaluate system response, a data transfer port for inputting specific data into the system and analyzing its processing, and a user interface for simulating user input during testing. Utilizing the virtual model allows manipulation of these interfaces to simulate various input conditions that may occur in a real system, enabling effective detection of unexpected security vulnerabilities.

During fuzz test execution, the virtual computer model is designed to monitor internal and external signals in real time. Assertion techniques are utilized for this purpose, with verification logic implemented to automatically activate when specific conditions are met. Assertions activate when certain code or operations deviate from expected conditions and can be implemented using programming languages within the virtual computer model. If an unexpected event occurs or normal operation is not maintained, the system detects and records the issue. This enables the virtual computer model of this invention to track internal state changes in real time during fuzz testing and analyze security events.

The primary objective of performing fuzz testing using the virtual computer model is to effectively detect and validate security vulnerabilities. If an assertion is triggered during fuzz test execution, it can be regarded as an indication of a security issue. This invention provides functionality to analyze such assertions in real time using an automatic assertion detection module and detect security events. The detected assertion data is analyzed using test coverage metrics, allowing for a quantitative evaluation of the test scope.

The virtual computer model (100) serves as a software-based model that provides a virtualized test environment for performing fuzz testing. It models the behavior and functions of the target system or specific designs (e.g., circuit designs, SoC designs) through software, enabling system validation without requiring actual hardware. This approach overcomes limitations encountered in traditional physical testing environments, allowing for more flexible and precise security validation.

This invention's virtual computer model can be implemented using programming languages such as SystemC, C++, and Python and includes real-time monitoring of internal system state changes and security events during fuzz testing. This enables the detection and analysis of unexpected behaviors during testing. Additionally, the system analyzes how fuzzed inputs are processed internally and is designed to trigger assertions when specific conditions are met to detect unforeseen security events.

As illustrated in FIG. 2, the virtual computer model consists of key components such as Interface (210), Computer Model (220), and Emulator (230). The Interface (210) functions to receive external inputs and transmit them to various components within the virtual computer model. It can process various test inputs such as network packets, data transmission ports, and user inputs. This capability allows for the analysis of the effects of unexpected inputs on the internal system and the detection of security vulnerabilities.

The Computer Model (220) operates at the software level, simulating the behavior of the target system. It replicates code execution flows and is used to detect unexpected events or errors. During fuzz test execution, it utilizes assertions to detect security vulnerabilities or functional errors, and the detected assertion data is used in test coverage evaluation (Test Coverage Analysis).

The Emulator (230) supports testing by virtualizing real hardware operations through software. In SoC design, it enables precise testing of major computing units such as GPUs and CPUs, enhancing modeling accuracy. Additionally, utilizing an FPGA-based emulation environment allows for more detailed validation at the hardware level. Assertions can also be executed within the emulator to detect and analyze abnormal behaviors that may occur at the hardware level.

During fuzz test execution, the virtual computer model (100) supports assertions at both software and hardware levels, effectively detecting security vulnerabilities. This model accepts and processes various inputs through the test interface, analyzing system behavior in the process. In network security testing, for example, it can process tampered packets, while in firmware testing, it can execute corrupted binaries to induce unexpected behaviors.

This invention's virtual computer model virtualizes the fuzz test environment through software, overcoming the limitations of traditional methods and enabling more efficient testing. By supporting assertions at both software and hardware levels, it can analyze internal state changes and security events in real time. As a result, test scope can be quantitatively evaluated, and security vulnerabilities can be effectively detected. As illustrated in the diagrams, the virtual computer model of this invention comprises Interface (210), Computer Model (220), and Emulator (230), each playing a crucial role in the fuzz testing process. By utilizing this system, automated testing is possible, enhancing the reliability and detection capabilities of fuzz testing.

### Auto Assertion Generator

To perform fuzz testing in a more structured manner, it is necessary to predefine expected security events and establish methods to detect them. The Auto Assertion Generator in this invention functions to automatically generate anticipated assertions before the execution of a test, based on the structure of the virtual computer model.

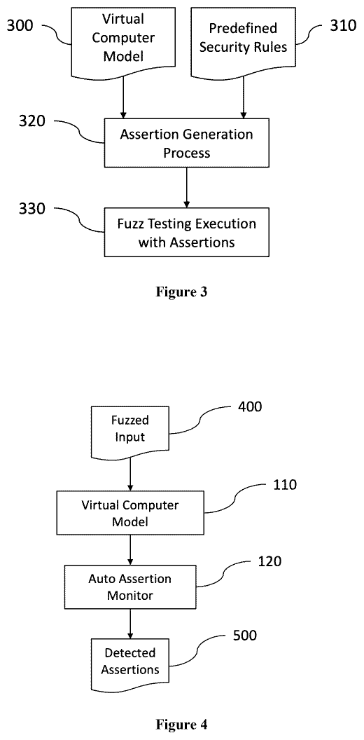

FIG. 3 illustrates the assertion generation process of this invention. Prior to executing the fuzz test, the Virtual Computer Model (300) serves as a software-modeled environment for the target system, operating at both software and hardware emulation levels while incorporating assertions capable of detecting specific security events.

Based on the analysis results of this model and the predefined security rules (310), the assertion generation process (320) is carried out. The predefined security rules define the security requirements and policies of the target system, providing criteria for distinguishing between normal operations and potentially risky actions during fuzz testing.

These predefined security rules are typically established based on the security policies of the target system, industry standards, and existing vulnerability databases such as CVE (Common Vulnerabilities and Exposures) and CWE (Common Weakness Enumeration).

CVE is a publicly available database that assigns unique identifiers to known security vulnerabilities, allowing security professionals to track and manage threats effectively. CWE, on the other hand, is a classification system that categorizes software and hardware weaknesses, helping organizations identify and mitigate security risks before they become exploitable vulnerabilities.

For example, security rules may include the following:
Security Policy-Based Rules:
   Certain files must be accessible only with administrator privileges.
   Network packets should only be received through designated ports.
Industry Standard-Based Rules:
   In accordance with automotive software safety regulations, the system must respond immediately upon receiving specific signals.
   According to credit card payment security standards, card numbers must be stored in an encrypted format.
Existing Vulnerability-Based Rules (CVE, CWE):
   Buffer Overflow: Assertions can be generated to detect memory accesses exceeding allowed bounds.
   SQL Injection: Assertions can be generated to detect cases where user inputs are directly embedded into SQL queries.

In this embodiment, these security rules are analyzed in the assertion generation process (320) and converted into assertions to be embedded within the target system for testing.

Generated assertions are applied during fuzz test execution and proceed to the Fuzz Testing Execution with Assertions (330) stage shown in the diagram. When fuzzed inputs are injected into the target system, assertions are triggered based on predefined conditions, allowing the evaluation of system behavior and the detection of security vulnerabilities. Traditional fuzz testing only verifies whether a system crashes, but this invention's auto assertion generation module enables a more precise analysis, detecting not only crashes but also specific security events.

Through this approach, the auto assertion generation module defines anticipated vulnerabilities before executing a test, ensuring that fuzz testing is performed in a more structured and comprehensive manner.

### Automatic Assertion Monitor

Detecting and analyzing security events in real-time during fuzz testing is a crucial factor in enhancing test effectiveness. The Automatic Assertion Monitor of this invention performs the function of detecting assertions occurring within the system in real time during fuzz test execution and analyzing the corresponding data.

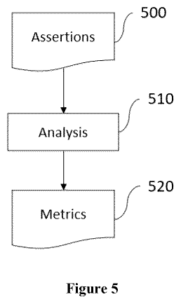

FIG. 4 schematically illustrates the function performed by the Automatic Assertion Monitor during the fuzz testing process of this invention. The fuzz test is executed by injecting Fuzzed Input (400) into the Virtual Computer Model (110), and as this input is processed within the system, unexpected behaviors may occur. If specific conditions are met in this process, the Auto Assertion Monitor (120) detects and records the assertion. The detected assertion data is then stored as Detected Assertions (500), where it serves as input data for security event analysis and test coverage evaluation (Test Coverage Analysis).

During fuzz test execution, various signal changes within the system are monitored, and assertions are triggered when specific conditions are satisfied. The Automatic Assertion Monitor detects these assertions and analyzes their frequency and impact, allowing for an assessment of how specific input values affect system behavior.

The real-time detection capability does more than merely record security events that occur during fuzz testing; it enables a quantitative analysis of test effectiveness and provides a clearer identification of where specific security vulnerabilities originate. Traditional methods require considerable time to analyze the root cause of a system crash or unexpected behavior. However, the Automatic Assertion Monitor of this invention can collect and analyze data in real time, enabling faster and more efficient security verification.

This invention injects Fuzzed Input (400) into the Virtual Computer Model (110) to induce unexpected behavior, thereby allowing the detection of security vulnerabilities. The Virtual Computer Model (110) is a software-modeled environment of the target system, where assertions can be executed at both software and hardware emulation levels while processing fuzzed inputs. In this process, the Auto Assertion Monitor (120) detects and records assertions occurring within the virtual computer model in real time. The detected assertion data is then used for security event analysis and test coverage evaluation.

The Detected Assertions (500) serve as data containing information about assertions that occurred during fuzz test execution. This data is utilized as input for security event analysis and test coverage evaluation. By leveraging the Automatic Assertion Monitor of this invention, the reliability of fuzz testing can be enhanced, and the risk of overlooking specific security vulnerabilities can be minimized.

### Test Coverage Analysis and Optimization

Fuzz testing is performed by injecting various input data into a system to induce unexpected behavior, thereby detecting security vulnerabilities. However, traditional fuzz testing methods have limitations in systematically analyzing which code areas have been sufficiently tested and whether specific vulnerabilities have been adequately verified. To address these issues, this invention includes a function that identifies untested code areas and evaluates whether undetected security vulnerabilities exist based on the analyzed assertion data.

FIG. 5 schematically illustrates the test coverage analysis process of this invention. This process consists of three main stages: detected assertions, coverage analysis, and test coverage metrics. Each stage quantitatively analyzes fuzz testing results to improve the reliability of security verification.

During fuzz testing, an assertion is triggered when the system exhibits unexpected behavior due to a specific input value. In FIG. 5, 500 represents the detected assertion data stored during fuzz testing. This data includes security event information, executed code lines, the relationship with the corresponding code block, the frequency of triggered assertions, and related fuzz test inputs. The collected assertion data serves as a critical element for evaluating test coverage in the coverage analysis stage.

In the coverage analysis stage, data from the detected assertions stage is used to assess which code has been tested and which parts have not been sufficiently verified. In FIG. 5, 510 represents the coverage analysis module, which utilizes various test coverage metrics to analyze test scope. These metrics may include code coverage, which measures the number of executed code lines relative to the total number of lines, function coverage, which assesses the number of executed functions relative to the total number, and path coverage, which analyzes the number of accessed code execution paths relative to the total possible paths. Additionally, assertion coverage evaluates how many assertions were triggered by specific inputs, and untested code areas analysis identifies code sections that were not executed. Through this coverage analysis, code areas that have not been sufficiently tested or have triggered fewer assertions than expected can be identified, enabling the quantitative assessment of test scope and the identification of areas with insufficient test coverage.

The test coverage metrics stage, represented by 520 in the figure, evaluates whether sufficient testing has been performed based on the results of the coverage analysis. If fuzz test inputs have not been applied to specific functions or code paths, additional testing may be necessary. Similarly, if certain test inputs repeatedly execute only the same code path, it may indicate insufficient testing of specific paths. This invention includes a function that automatically identifies untested code areas and recommends additional fuzz test applications as needed. Through test coverage analysis, this invention's fuzz testing system can quantitatively evaluate test scope, identify unverified code areas, and improve security vulnerability detection rates. This enables the identification of tested code regions and areas requiring further verification, providing a more precise security assessment than existing methods. Additionally, by analyzing security events in real-time during testing, the reliability of fuzz testing can be enhanced.

The test coverage analysis function of this invention supports the automatic identification of untested code areas and, if necessary, facilitates additional testing. This enhances the reliability of fuzz testing and prevents certain security vulnerabilities from being overlooked. To complement the identification of untested code areas and insufficient test application through test coverage analysis, this invention applies additional optimization techniques. First, the dynamic input generation technique can be used to focus testing on untested code areas. While traditional fuzz testing primarily relies on generating random inputs, this invention applies an approach that adjusts inputs based on the results of test coverage metrics (520). For example, if assertions rarely occur in a specific code block, input data that can activate that code area can be preferentially generated.

Furthermore, the assertion-guided testing technique is applied to automatically explore input values that can lead to different execution paths if test inputs repeatedly execute the same code path. This addresses the issue of tests being confined to limited code regions and ensures the evaluation of various execution paths within the system.

Lastly, a test feedback loop is utilized to apply optimizations based on test execution results. Assertion data and test coverage analysis results are used to evaluate whether specific test inputs effectively detect security vulnerabilities. If necessary, additional testing strategies are applied. For instance, if certain assertions are not consistently triggered, new fuzz inputs targeting those code paths can be generated, or specific variables can be modified to adjust the test environment.

By incorporating these optimization techniques, this invention's fuzz testing system enables more efficient test application than conventional random input generation methods, maximizing security vulnerability detection rates. This improves the reliability of testing and enables more precise security verification than existing fuzz testing methods.

### Fuzz Testing Process Flow

Fuzz testing is performed by injecting various input data into a system to induce unexpected behavior, thereby detecting security vulnerabilities. This invention establishes a test environment based on a virtual computer model, incorporating automatic assertion generation and detection functions to enable more effective fuzz testing.

### Fuzz Testing Execution Process

Fuzz testing generates random input data, injects it into the virtual computer model, and triggers assertions when certain conditions are met. These assertions are then analyzed to detect security vulnerabilities. The fuzz testing execution process in this invention proceeds as follows. First, the fuzz tester generates various types of random inputs (fuzzed input) and injects them into the virtual computer model. The injected input is processed within the system and may cause unexpected behavior. During this process, the automatic assertion generation module executes predefined assertions, which are triggered if specific conditions are met.

During fuzz testing execution, the automatic assertion monitor detects and records triggered assertions in real time. The detected assertion data is then utilized in test coverage analysis and test coverage metrics, which evaluate test coverage and identify areas requiring additional verification.

### Fuzz Tester: Generating and Injecting Random Inputs

The fuzz tester is responsible for injecting various inputs into the system to induce unexpected behavior and detect security vulnerabilities. The generated random input data can take various forms depending on the characteristics of the target system.

For example, in network security testing, malformed network packets can be generated, while in file system verification, corrupted file inputs can be used. Additionally, for detecting software vulnerabilities, random command sequences can be injected, and for hardware interface testing, manipulated sensor data can be applied.

The generated input data is then injected into the virtual computer model, where the system's response is monitored to identify unexpected behaviors.

### Virtual Computer Model: Processing and Analyzing Input Data

When fuzzed input is injected into the virtual computer model, the system processes it, altering the execution flow and potentially triggering unexpected events. For instance, a specific code block may execute and cause a memory access error, or an action violating security policies may occur.

During this process, the automatic assertion generation module activates predefined assertions that evaluate system behavior. If certain conditions are met, assertions are triggered, indicating the presence of potential security vulnerabilities.

Automatic Assertion Monitor: Detecting and Recording Assertions During Execution

During fuzz testing execution, the automatic assertion monitor detects and records security events occurring within the system in real time. For example, assertions may be triggered if unexpected memory access occurs in a specific code block, anomalous network packets are received, or an exception is raised.

The detected assertions are then utilized in test coverage analysis, where they help assess test coverage and verify whether specific security vulnerabilities have been thoroughly tested.

### Test Coverage Analysis and Test Coverage Metrics

After fuzz testing execution, test coverage analysis is conducted based on detected assertion data to evaluate the extent of test coverage.

Test coverage is assessed using various metrics, including:
Code coverage: The number of executed code lines compared to the total number of lines
Function coverage: The number of executed functions compared to the total number of functions
Path coverage: The number of accessed execution paths compared to the total possible paths
Assertion coverage: The number of assertions triggered by fuzz inputs
Untested code areas: Identification of unexecuted code paths requiring further testing

Through this analysis, untested code areas can be identified, and additional verification requirements can be determined.

### Optimized Execution of Fuzz Testing

To enhance the efficiency of fuzz testing execution, this invention applies various optimization techniques to dynamically adjust the test environment and maximize execution efficiency. First, dynamic input adaptation allows the system to analyze the impact of existing test inputs in real time and generate new inputs targeting untested code areas. For example, if assertions are rarely triggered in a specific code block, input data that can activate that area is preferentially generated to expand test coverage.

Additionally, adaptive test iteration analyzes detected assertion data during testing and dynamically adjusts the test environment. If the same test input repeatedly executes a specific code path, new inputs are generated to diversify code execution paths. This prevents tests from focusing on a limited range of paths and ensures comprehensive system-wide testing.

Furthermore, parallel fuzz testing enhances execution speed by running multiple virtual computer models simultaneously, each applying different input data. This maximizes testing efficiency, rapidly expands test coverage, and effectively detects a wide range of vulnerabilities. By incorporating these optimization techniques, this invention enables more sophisticated and efficient fuzz testing execution compared to conventional random input generation methods, maximizing security vulnerability detection rates. This enhances test reliability and allows for more precise security verification than traditional fuzz testing methods.

### EMBODIMENTS OF THE INVENTION

The fuzz testing system of this invention can be used to detect and verify security vulnerabilities across various industries and environments. Traditional fuzz testing methods have primarily been conducted at the software application level. However, this invention utilizes a virtual computer model to conduct tests at the hardware and embedded system levels as well. This enables security verification in a broader range of environments while allowing real-time monitoring of the system's internal state.

Traditional fuzz testing methods have mainly focused on detecting security vulnerabilities by verifying input values in software applications or manipulating network packets. However, the system of this invention is designed to be applicable not only to software but also to various other fields, such as hardware and embedded systems, network equipment, financial systems, aerospace, and semiconductor design environments. In particular, this system is designed to analyze in real time how unexpected inputs affect system behavior through automatic assertion generation and monitoring functions.

Based on these technologies, the fuzz testing system of this invention can be applied in various industries, including network security, automotive ECU security verification, IoT device and firmware security evaluation, financial systems and cryptographic software testing, and aerospace and semiconductor system security verification.

### Network Security Testing

Network security testing is one of the most actively utilized areas for fuzz testing. It focuses on detecting errors that occur when firewalls, IDS/IPS (intrusion detection and prevention systems), VPN gateways, web servers, and other network devices and security software process unexpected inputs.

The fuzz testing system of this invention can simulate various network protocols and security systems using a virtual computer model and inject abnormal traffic to detect unexpected behavior. For example, it can evaluate whether incorrectly formatted packets bypass the firewall, whether network devices enter a denial-of-service (DOS) state due to specific inputs, and whether evasion attacks are possible.

Additionally, this system enhances network security for enterprises and organizations by detecting vulnerabilities in SSL/TLS protocols, simulating SSH and VPN authentication bypass attacks, testing fuzzed HTTP requests, and performing SQL injection attack simulations.

### Automotive ECU Security Testing

The electronic control unit (ECU) of a vehicle is a core component responsible for critical functions. If security vulnerabilities exist, hackers could remotely control the vehicle, leading to severe security threats. In particular, communication protocols used in in-vehicle networks, such as CAN, LIN, and automotive Ethernet, may be vulnerable to external attacks, potentially allowing malicious manipulation of essential vehicle functions.

The fuzz testing system of this invention simulates automotive ECUs and internal network environments through a virtual computer model to evaluate how a vehicle responds to abnormal input data. For example, it can verify whether a vehicle responds correctly when an unexpected CAN message is sent to the brake system and whether the vehicle's over-the-air (OTA) software update system rejects malicious firmware updates.

In particular, this system can also be applied to detecting security vulnerabilities in autonomous vehicles and advanced driver assistance systems (ADAS). It enables security enhancement by testing whether manipulated sensor data causes the autonomous driving system to malfunction and evaluating whether attacks through the in-vehicle network are possible.

### Firmware & IoT Device Security Testing

IoT (Internet of Things) devices and embedded systems combine physical hardware with network connectivity, and security vulnerabilities in these systems can cause significant physical damage. If the security of smart home devices, medical devices, industrial IoT sensors, and smart factory equipment is compromised, attackers may be able to remotely control these devices.

The fuzz testing system of this invention can analyze the firmware of IoT devices and inject abnormal inputs to detect unexpected system reactions. For example, it can test whether a smart door lock's authentication system is vulnerable to bypass attacks or whether a medical device's remote update system accepts malicious firmware.

### Financial Systems & Cryptographic Software Testing

Financial systems require particularly high security, necessitating security verification for online payment systems, cryptographic software, blockchain networks, stock market analysis systems, and more. By using the fuzz testing system of this invention, financial institutions can evaluate whether financial systems correctly process abnormal transactions, whether encryption keys are securely protected, and whether financial data remains unaltered.

In particular, for high-performance computing (HPC) systems used in financial applications, this system can test whether erroneous input data causes stock prediction models to behave abnormally and assess whether financial transaction systems can withstand external attacks.

### Aerospace & Semiconductor Security Testing

Aerospace and semiconductor systems require extremely high reliability and security. Unexpected inputs or external attacks could lead to catastrophic consequences.

The networks of aircraft and satellites continuously exchange data with ground control stations, making it crucial to verify whether systems function correctly even when data manipulation occurs. The fuzz testing system of this invention can be used to evaluate how aerospace control systems respond to abnormal input data, electromagnetic interference (EMI), or cyberattacks.

In semiconductor design and manufacturing, this system can detect hardware security vulnerabilities in system-on-chip (SoC) and FPGA-based designs. It can also be applied in the early stages of chip design to identify potential hardware trojans and perform security validation. These capabilities strengthen hardware security and improve the resilience of semiconductor hardware against attacks.

### Scalability & Future Applications

The fuzz testing system of this invention can be integrated with AI and machine learning-based test automation in the future and can also be applied to large-scale security testing environments in cloud computing. This maximizes the efficiency of fuzz testing and enables more precise security verification across various industries.

By combining AI and machine learning-based test automation, the fuzz testing system of this invention can significantly improve testing efficiency. Machine learning algorithms can analyze detected security events to prioritize areas most likely to contain vulnerabilities, enabling a more sophisticated fuzzing approach than traditional random input generation methods.

Additionally, large-scale parallel testing can be conducted using cloud environments, allowing multiple virtual computer models to run simultaneously and assess different test scenarios. This enhances testing speed and facilitates scalable security verification in large-scale systems.

With these scalability features, this system can be applied in diverse fields, including autonomous vehicles, smart factories, financial transaction monitoring, and national infrastructure security assessments. Furthermore, by continuously automating security testing, it can effectively respond to emerging threats in real time.

### TECHNICAL ADVANTAGES

The fuzz testing system of this invention provides various technical advantages that enhance security vulnerability detection capabilities, testing efficiency, and reliability compared to conventional fuzz testing methods. Traditional fuzz testing primarily operates by modifying external input values to induce unexpected behaviors. However, these methods lack real-time analysis of internal state changes, making it difficult to determine the root causes of security events. Additionally, conventional fuzz testing methods struggle to quantitatively evaluate test coverage, making it challenging to assess whether specific vulnerabilities have been adequately verified.

The fuzz testing system of this invention utilizes a virtual computer model to conduct tests not only at the software level but also at the hardware and firmware levels. It enables real-time monitoring of both internal and external signals, allowing for more precise analysis of security events. Furthermore, it incorporates automatic assertion generation and detection functions, facilitating the evaluation of how unexpected inputs impact system behavior and enabling quantitative measurement of test coverage.

The first advantage is the enhanced detection rate of security vulnerabilities. Traditional fuzz testing methods primarily focus on observing whether a system crashes or exhibits abnormal behavior, often leading to missed internal security events. In contrast, this invention utilizes assertions executed within the virtual computer model to perform a more detailed analysis of how unexpected inputs affect the system. This allows for verification of whether specific security policies are correctly implemented. For instance, it can detect security issues such as network security devices improperly allowing certain packets or an automotive ECU responding abnormally to unexpected CAN messages.

The second advantage is the cost reduction achieved through test automation. Conventional fuzz testing often requires manual test scenario design and time-consuming analysis of logs generated during test execution. The fuzz testing system of this invention automates the post-execution analysis process using automatic assertion generation and detection functions. It also employs test coverage analysis to automatically identify untested areas. This reduces human labor and time costs associated with security verification, enabling more efficient testing procedures.

The third advantage is the ability to perform quantitative test coverage analysis. Traditional fuzz testing methods assess whether a system crashes or experiences specific errors, making it difficult to evaluate how thoroughly the entire system has been tested. The fuzz testing system of this invention utilizes various metrics such as executed code lines, function coverage, path coverage, and assertion coverage to quantitatively assess test application. This allows for the identification of unverified code areas and ensures that additional testing is conducted where necessary, ultimately improving test reliability.

Additionally, the fuzz testing system of this invention is applicable not only to software but also to hardware and firmware, providing greater scalability than conventional fuzz testing methods. Traditional fuzz testing primarily targets application software, whereas this invention enables security verification at the hardware and firmware levels using a virtual computer model. It can be utilized for assessing the security of automotive ECUs, identifying firmware vulnerabilities in network routers and firewalls, and detecting hardware trojans in aerospace and semiconductor systems.

In conclusion, the fuzz testing system of this invention enhances security vulnerability detection rates, reduces costs and time through test automation, and provides the ability to quantitatively evaluate test coverage. Furthermore, its applicability extends to hardware and firmware security verification, making it a valuable tool across various industries. By overcoming the limitations of conventional fuzz testing methods, this invention enables more precise and reliable security verification.

### ALTERNATIVE IMPLEMENTATIONS

The fuzz testing system of this invention is not limited to a specific implementation method and can be modified and expanded in various ways. The fuzz testing technique utilizing a virtual computer model, as proposed in this invention, can be applied across different environments and systems and can be optimized according to the characteristics of hardware and software. This allows for broad security verification without being restricted to specific system architectures or development environments.

The first alternative implementation involves various methods of implementing the virtual computer model. The virtual computer model of this invention can be implemented using different approaches such as SystemC, QEMU, and FPGA-based emulation. For example, SystemC is a language that allows for software-based modeling of hardware designs and is widely used in System-on-Chip (SoC) design and verification. The fuzz testing system of this invention can leverage SystemC to build virtual models of processors, memory, and interfaces and conduct security verification based on these models. Additionally, QEMU is an open-source software that provides virtualization and emulation capabilities, enabling execution across different hardware architectures in a virtual environment. The fuzz testing system of this invention can utilize QEMU to perform security testing on various processor environments such as x86, ARM, and RISC-V. Furthermore, by using FPGA-based emulation, security testing can be conducted in an environment closely resembling actual hardware, allowing for more precise hardware security verification.

The second alternative implementation involves applicability in various types of testing environments. The fuzz testing system of this invention can be applied not only to software but also to hardware and firmware systems and can be optimized depending on the target system. For example, in software systems, it can be used to test security vulnerabilities in operating system kernels, applications, and network protocols, while in hardware systems, it can verify security in embedded firmware for automotive ECUs, industrial control systems (ICS), and network devices.

Particularly in embedded system environments such as automotive ECUs and aerospace systems, real-time software testing is crucial. The fuzz testing system of this invention utilizes a virtual model to detect security vulnerabilities in embedded systems in advance. For example, by conducting fuzz testing on the CAN communication protocol within an automotive ECU, the system's response to unexpected messages can be evaluated. In aerospace systems, it can verify whether unexpected inputs in flight control software and satellite communication systems cause operational failures.

The third alternative implementation involves machine learning and Al-based fuzz test automation. Traditional fuzz testing methods primarily generate random inputs, but by utilizing machine learning techniques, more effective test inputs can be generated. The fuzz testing system of this invention employs machine learning algorithms to automatically optimize test inputs and generate unpredictable input patterns, thereby enhancing the detection of security vulnerabilities. For instance, by utilizing reinforcement learning algorithms, the system can learn from its responses and automatically establish more effective fuzzing strategies.

Additionally, this invention can be extended to a cloud-based fuzz testing system. Traditional fuzz testing is typically executed in local environments, which limits computing resources. However, performing fuzz testing in a cloud environment allows for large-scale parallel processing and reduces test execution time. For example, multiple test instances can be executed in parallel using virtual machines (VMs) or containerized environments in the cloud, enabling faster and more efficient security verification.

In conclusion, the fuzz testing system of this invention is not limited to a specific implementation and can be expanded in various ways. It supports multiple virtual computer model implementations (SystemC, QEMU, FPGA-based emulation), diverse testing environments (software, hardware, and firmware systems), machine learning and AI-based automation, and cloud-based fuzz testing environments. This enables broad industrial applications, expanding the scope of security verification and facilitating more precise and efficient fuzz testing.

### CONCLUSION AND FUTURE PROSPECTS

This invention proposes a fuzz testing system and method utilizing a virtual computer model, enabling more precise and reliable security verification by overcoming the limitations of traditional fuzz testing methods. Conventional fuzz testing techniques primarily involve manipulating external system inputs to induce unexpected behaviors. However, they lack real-time analysis capabilities for internal state changes and face challenges in quantitatively evaluating test coverage.

The fuzz testing system of this invention is based on a virtual computer model that enables real-time monitoring of internal and external signals, allowing for the analysis of the impact of unexpected inputs on the system. Additionally, by leveraging automatic assertion generation and detection functionalities, the system can more precisely detect security events and quantitatively assess test coverage. This results in improved security vulnerability detection rates compared to traditional methods, reduced costs and time through test automation, and a more systematic approach to evaluating test coverage.

This invention is applicable across various industries. It can be utilized not only for software applications and operating system security verification but also for automotive ECUs, aerospace systems, financial transaction systems, network and communication devices, semiconductor and hardware firmware security testing, and more. Furthermore, the technology can be advanced through integration with machine learning and AI-based fuzz test automation, cloud-based test scalability, and FPGA-based hardware emulation.

From a research and future development perspective, AI-driven fuzz test automation enables the intelligent generation of test inputs, allowing the system to learn from its responses and automatically establish optimized fuzzing strategies. Additionally, assertion optimization using machine learning can enhance the detection of security events, while advancements in test coverage analysis can provide a more precise measurement of the effectiveness of fuzz testing.

In conclusion, the fuzz testing system of this invention addresses the limitations of conventional fuzz testing methods, providing a more precise and reliable security verification approach. It can be applied across various industries and security environments, and with further integration of AI and cloud technologies, it has the potential to evolve into an even more scalable and advanced security testing solution.

1. A fuzz testing system, comprising:
a virtual computer model;
wherein the virtual computer model virtualizes a target system, monitors internal and external signals, and ·detects security vulnerabilities and evaluates the normal operation of the system.

2. The fuzz testing system of claim 1, comprising:
an auto assertion generator;
wherein the auto assertion generator analyzes the structure and operation of the virtual computer model;
automatically generates assertions based on predefined security criteria or expected security event conditions; and
verifies the operation of the system during fuzz test execution.

3. The fuzz testing system of claim 1, comprising:
an auto assertion monitor that monitors internal and external signals of the virtual computer model in real-time and collects detected assertion data; and
records and stores the conditions, frequency, and impact of the detected assertions.

4. The fuzz testing system of claim 1, comprising:
a coverage analysis module that analyzes the test coverage scope, untested code areas, and reliability of the test based on the detected assertion data;
wherein the coverage analysis module calculates coverage metrics that quantitatively evaluate the test coverage; and
identifies code blocks that were not tested or insufficiently verified and evaluates the need for additional testing.

5. A fuzz testing method, comprising:
a test environment setup step that:
virtualizes a target system using a virtual computer model;
configures a test interface to collect input data from the target system and convert it for fuzz testing; and
establishes a real-time monitoring system to detect and analyze internal and external signals.

6. The fuzz testing method of claim 5, comprising:
an automatic assertion generation step that:
utilizes an auto assertion generator;
analyzes the structure of the virtual computer model; and
generates assertions based on predefined security criteria.

7. The fuzz testing method of claim 6, comprising:
a fuzz test execution step that:
executes a fuzz test on the virtual computer model with the generated assertions.

8. The fuzz testing method of claim 7, comprising:
an assertion evaluation step that:
analyzes the assertions generated during the fuzz test execution; and
provides test effectiveness as coverage metrics.

9. The fuzz testing method of claim 8, comprising:
a coverage analysis step that:
evaluates whether assertions were not triggered or had low frequency, based on the analyzed assertion data; and
identifies code blocks that were not tested or insufficiently verified and evaluates the need for additional testing.

10. The fuzz testing method of claim 5, comprising:
a test execution optimization step that:
automatically adjusts test environment parameters, test input types, or assertion detection conditions based on analysis results to improve the efficiency and security vulnerability detection rate of fuzz testing.

11. The fuzz testing method of claim 10, comprising:
wherein the test execution optimization step:
dynamically generates fuzzed inputs or adjusts existing inputs based on collected assertion occurrence frequency, code coverage data, or error occurrence information to target untested code areas or unverified behaviors.

12. The fuzz testing method of claim 10, comprising:
wherein the test execution optimization step:
iteratively adjusts test input generation methods or assertion detection rules based on collected data or predefined test strategies in an adaptive test iteration process.

13. The fuzz testing method of claim 10, comprising:
wherein the test execution optimization step:
is executed in a parallel processing manner using a virtual computer model; and
applies different test inputs simultaneously to reduce test time and expand code coverage in a parallel fuzz testing process.
